(19) United States
(12) Patent Application Publication
(10) Pub. No.: US 2005/0198900 A1
(43) Pub. Date: Sep. 15, 2005

(54) Method and apparatus for fuel/air preparation for a hydrocarbon reformer

(76) Inventors: Richard F. Nashburn, Honeoye Falls, NY (US); John E. Kirwan, Troy, MI (US); Kenneth J. Dauer, Lima, NY (US); Michael R. Salemi, Rochester, NY (US); Gregory W. Sterman, Penfield, NY (US); Jonathon R. Bennett, Lima, NY (US)

Correspondence Address: DELPHI TECHNOLOGIES, INC., M/C 480-410-202, PO BOX 5052, TROY, MI, 48007, US

(21) Appl. No.: 11/115,453

(22) Filed: Apr. 27, 2005

Related U.S. Application Data
(63) Continuation-in-part of application No. 10/229,550, filed on Aug. 28, 2002.

(51) Int. Cl. C01B 3/32

(52) U.S. Cl. 48/198.7; 48/127.9

(57) ABSTRACT

A catalytic reformer assembly and methods of operation, including fast start-up. The reformer assembly includes a reactor for receiving hydrocarbon fuel and air and a reforming catalyst within the reactor for converting the fuel and air to hydrogen-containing reformate. The assembly further includes a heat exchanger that straddles the reformer such that gases entering and leaving the reformer pass through opposite sides of the heat exchanger. A combustor ahead of the heat exchanger includes a first fuel injector and igniter. A fuel/air mixture may be either ignited at start-up to quickly heat both sides of the heat exchanger, the reactor, and the reformer, or passed into the reactor for reforming at steady state. A second fuel injector may be provided in the reactor. The two fuel injectors may have overlapping flow ranges and may be used separately or in tandem to provide a broad range of reformate flow.

### RELATIONSHIP TO OTHER PATENTS AND APPLICATIONS

The present application is a Continuation-In-Part of a pending U.S. patent application Ser. No. 10/229,550, filed Aug. 28, 2002.

### TECHNICAL FIELD

The present invention relates to a catalytic reformer and method for converting a hydrocarbon stream to a reformate fuel stream comprising hydrogen; and more particularly, to a fast light-off catalytic reformer and methods for rapid production of reformate and for steady state operation. The present invention is useful for providing reformate as a fuel to a fuel cell, especially a solid oxide fuel cell, and to an internal combustion engine.

### BACKGROUND OF THE INVENTION

A catalytic hydrocarbon fuel reformer converts a fuel stream comprising, for example, natural gas, light distillates, methanol, ethanol, higher alcohols, propane, naphtha, kerosene, gasoline, diesel fuel, or combinations thereof, and air, into a hydrogen-rich reformate fuel stream comprising a gaseous blend of hydrogen, carbon monoxide, and nitrogen (ignoring trace components). In the reforming process, the raw hydrocarbon fuel stream is typically percolated with oxygen in the form of air through a catalyst bed or beds contained within one or more reactor tubes mounted in a reformer vessel. The catalytic conversion process is typically carried out at elevated catalyst temperatures in the range of about 700° C. to about 1100° C.

The produced hydrogen-rich reformate stream may be used, for example, as the fuel gas stream feeding the anode of an electrochemical fuel cell such as, for example, a solid-oxide fuel cell (SOFC) system The reformate stream may also be used as a hydrogen fuel to fuel an internal combustion (IC) engine, either alone or in combination with gasoline or diesel fuel. Another use of the reformate stream may be to deliver it into the exhaust stream of an IC engine to increase light-off rate or improve emissions reduction performance of exhaust components such as exhaust catalysts, NOx adsorbers, and/or particulate filters.

A problem in the past has been how to elevate the temperature of the reforming catalyst quickly at start-up in order to begin generating reformate in a very short time. One approach has been to incorporate into the reformer a “fast light-off” system wherein a fuel/air mixture, essentially stoichiometric, is ignited in the reformer, preferably upstream of the catalyst, for a brief period at start-up. The exhaust gas, passing through the reformer in contact with the catalyst, heats the catalyst very rapidly. Such combustion typically is needed for only a few seconds, after which ignition is terminated and the mixture is made very fuel-rich for reforming.

It is known to provide a heat exchanger having first and second sides. Hot reformate is passed through the second side, and incoming air is passed through the first side, and thus the incoming air required for reforming is desirably heated. A problem exists in this approach, however, in that the fast light-off combustion can heat only the second side of the heat exchanger, and the combustion exhaust gases have already been cooled significantly by passage through the cold reactor prior to reaching the heat exchanger.

What is needed is a means for rapidly heating incoming air for vaporizing and air-mixing the fuel being provided to a catalytic fuel reformer.

It is a primary object of the invention to more fully preheat the entire reformer assembly, including the heat exchanger, so as to better heat incoming air for a catalytic fuel reformer during warm-up of the reformer.

### SUMMARY OF THE INVENTION

A catalytic reformer assembly and methods of operation, including fast start-up, are provided. The reformer assembly includes a reactor having an inlet for receiving a flow of hydrocarbon fuel and a flow of air, a reforming catalyst disposed within a reforming chamber in the reactor for converting the fuel and air to a hydrogen-containing reformate stream, and an outlet for discharging the produced reformate stream. The assembly further includes a heat exchanger such that gases entering the reformer and gases leaving the reformer pass through opposite sides of the heat exchanger. A combustor ahead of the heat exchanger includes a first fuel injector and igniter. A fuel/air mixture formed in the combustor may be either ignited (as at start-up) to quickly heat both sides of the heat exchanger, the reactor, and the reformer, or passed into the reactor for reforming (as at steady state). Optionally, a second fuel injector also may be provided in the reactor itself. The first and second fuel injectors may have different and overlapping flow ranges and may be used separately or in tandem to provide a broad range of reformate flow.

Placing the heat exchanger between the combustor and the reactor provides for very rapid heating of the entire assembly at start-up and shortens the non-productive time of the reformer.

### BRIEF DESCRIPTION OF THE DRAWINGS

Referring now to the drawings, which are meant to be exemplary and not limiting:

FIG. 1 is an isometric view, partially in section, of a first prior art catalytic reformer assembly;

FIG. 2 is a cross-sectional view of a second prior art catalytic reformer assembly adapted for fast light-off; and

FIG. 3 is a cross-sectional view of a fast light-off catalytic reformer assembly as modified in accordance with the invention.

### DESCRIPTION OF THE PREFERRED EMBODIMENT

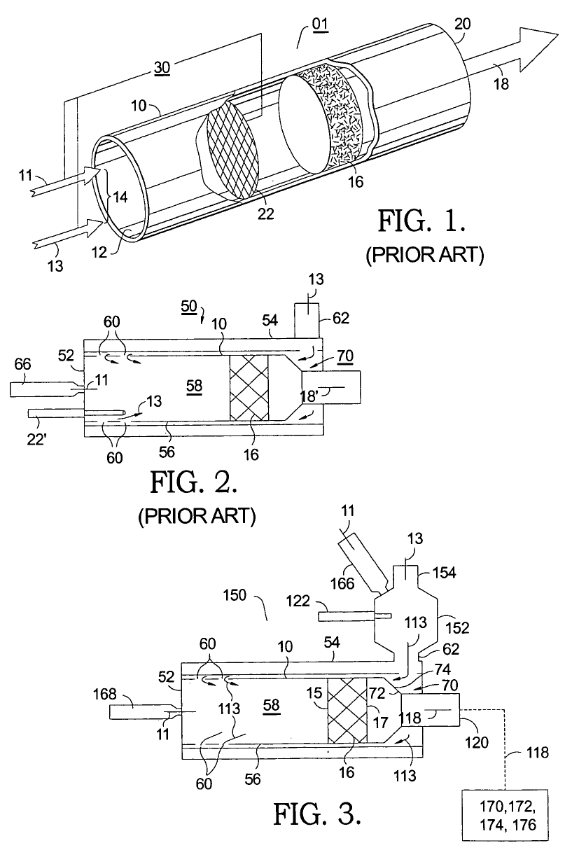

Referring to FIG. 1, a first prior art catalytic reformer assembly 01 includes a reactor 10 having an inlet 12 in a first end for receiving a flow of fuel 11 and a flow of air 13, shown as combined fuel-air mixture 14. Reactor 10 may be any shape, but preferably comprises a substantially cylindrical reactor tube. Reforming catalyst 16 is disposed within reactor 10. A protective coating or firewall (not shown) may be disposed about catalyst 16.

During operation, fuel-rich mixture 14 comprising air 13 and hydrocarbon fuel 11 such as natural gas, light distillates, methanol, ethanol, higher alcohols, propane, naphtha, kerosene, gasoline, diesel fuel, or combinations thereof, is converted by catalyst 16 to a hydrogen rich reformate fuel stream 18 that is discharged through outlet 20.

Ignition device 22 is disposed within reactor 10 to ignite fuel/air mixture 14 as desired. Heat generated by this reaction is used to provide fast light-off (i.e., rapid heating) of reforming catalyst 16. Ignition device 22 is disposed within the reactor 10 upstream of reforming catalyst 16, i.e., between inlet 12 and reforming catalyst 16. Ignition device 22 may be any device suitable for initiating exothermic reactions between fuel and air 14, including, but not limited to, a catalytic or non-catalytic substrate, such as a wire or gauze as shown in FIG. 1, for receiving electric current from a voltage source; a spark plug; a glow plug; or any combination thereof. An associated control system 30 selects and maintains the appropriate fuel and air delivery rates and operates the ignition device 22 so as to achieve fast light off of the reforming catalyst 16 at start-up and to maintain catalyst 16 at a temperature sufficient to optimize reformate 18 yield.

Prior art reformer assembly 01 has no provision for preheating of either incoming fuel 11 or air 13 and thus is not directed to capability for providing either fast light-off or optimal steady-state operating conditions for generation of reformate 18.

Referring to FIG. 2, a second fast light-off catalytic fuel reformer assembly 50 as disclosed in the referenced pending application Ser. No. 10/229,550, is shown. Reformer assembly 50 includes means for shortening the light-off induction period of the reformer. Components thereof having identical function are identically numbered, and those having similar or improved function are identically numbered with a prime indicator ′. New components bear new numbers.

In reformer assembly 50, inlet 12 is eliminated and that end of reactor 10 is blocked by end plate 52. A jacket 54 is provided concentric with reactor 10 and defining an annular chamber 56 therebetween which is closed at both axial ends. Chamber 56 communicates with reforming chamber 58 within reactor 10 via a plurality of openings 60 formed in the wall of reactor 10. Air 13 for combustion and for reforming enters reformer assembly 50 via inlet duct 62 formed in the wall of jacket 54. Combustion fuel 11 is injected by a first fuel injector 66 mounted in end plate 52 directly into reforming chamber 58 during combustion mode where the fuel mixes with air 0.13 entering from chamber 56 via openings 60. An igniter 22′, preferably a spark plug or other sparking device, disposed through end plate 52 of reactor 10 into chamber 58. Reforming catalyst 16 is disposed in reactor 10 downstream of the flow of mixture 14 through chamber 58. Downstream of catalyst 16 is a heat exchanger 70. Intake air 13 is passed through a first side of heat exchanger 70 and hot gases 18′ exiting catalyst 16 are passed through a second side, thus heating intake air 13.

A shortcoming of reformer assembly 50 is that at start-up the only heat reaching the second side of heat exchanger 70 is residual combustion heat in gases from chamber 58 which have already given up a substantial percentage of heat into the elements of reforming catalyst 16 and the walls of reactor 10. A further shortcoming is that no heat at all is provided directly to the first side of heat exchanger 70.

Referring to FIG. 3, an improved reformer assembly 150 in accordance with the invention is structurally similar in many respects to assembly 50 as shown in FIG. 2. End plate 52 closes the inlet end of reactor 10. Catalyst 16, having upstream side 15 and downstream side 17, is disposed in reactor 10. A jacket 54 is provided concentric with reactor 10 and defining an annular chamber 56 therebetween which is closed at both axial ends. Chamber 56 communicates with reforming chamber 58 within reactor 10 via a plurality of openings 60 formed in the wall of reactor 10. A combustor 152 is mounted on jacket 54 of reactor 10 in communication with inlet duct 62. Air 13 for combustion and for reforming enters reformer assembly 150 via an inlet duct 154 into combustor 152. Combustion fuel 11 is injected by a first fuel injector 166 mounted in combustor 152 and forms a combustible fuel/air mixture within the combustor. An igniter 122, preferably a spark plug or other sparking device, is also disposed through a wall of combustor 152. Optionally, a second fuel injector 168 may be provided extending through reactor end plate 52 similarly to injector 66 in FIG. 2. Reforming catalyst 16 is disposed in reactor 150 downstream of the flow of gases through chamber 58. Downstream of catalyst 16 is a second side 72 of a heat exchanger 70. Gases 118 flowing from or through catalyst 16 are passed through the second side, and gases 113 flowing from combustor 152 are passed through a first side 74 of heat exchanger 70. Thus, both sides of heat exchanger 70 are heated by combustion in combustor 152. FIG. 3 shows a the heat exchanger configured in a simple tube-in-tube counterflow arrangement. It should be appreciated that the heat exchanger can be of a different type that performs the same function of transferring heat from the reformate to the incoming air.

For clarity, combustor 152 is shown in FIG. 3 as being separate from and additional to reactor 10. It should be appreciated that in an actual embodiment, the combustor is preferably integrated in packaging with the reformer to reduce overall size and to reduce heat losses from the combustor to its surroundings.

Reformer assembly 150 may be operated in any of several ways, depending upon a specific application or upon the operational status of the reformer.

In a first method in accordance with the invention, during start-up from a cold start, fuel 11 is injected by fuel injector 166 into combustor 152 (fuel injector 168 is deactivated), mixed with air 13 in a near-stoichiometric ratio, and ignited by igniter 122 to form hot exhaust gases 113 which immediately begin to heat the first side of heat exchanger 70 and are passed via annular chamber 56 and openings 60 into and through reactor 10 where they heat the walls of the reactor, heat catalyst element 16, and heat the second side of heat exchanger 70 as spent gases 118.

This start-up method, allowed by the configuration of improved assembly 150, is superior to start-up of assembly 50 because the start-up combustion for heating occurs ahead of the first side of the heat exchanger, rather than ahead of only the second side as in the prior art; thus, the heat exchanger is heated much more rapidly by having hot gases passing through both sides.

After combustion has proceeded for a few seconds, ignition by igniter 122 in the combustor is terminated, the fuel ratio is made richer in fuel, and the unburned fuel/air mix is passed into the reactor after being preheated by the hot first side of the heat exchanger. Because the fuel/air mixture reaching the catalyst is much hotter than in the prior art, reforming catalysis is better during reformer warm-up. In this embodiment, second fuel injector 168 may be omitted.

In an alternative second method of operating reformer assembly 150, at the conclusion of combustion, fuel injector 166 is shut down as well as igniter 122, and fuel injection is commenced by fuel injector 168. Operation then proceeds as in embodiment 50 shown in FIG. 2. Again, because the fuel/air mixture reaching the catalyst at that time is much hotter than in the prior art, reforming catalysis is better during reformer warm-up.

In an alternative third method of operating reformer assembly 150, at the conclusion of combustion, igniter 122 is shut down, but both fuel injectors 166, 168 are used to provide fuel for steady-state reforming. An advantage is that one injector can be sized to optimize fuel delivery over a flow range lower than the maximum required for maximum reforming, and the other injector can be optimized for a higher flow rate. When the required reformate flow is high, the required fuel flow rate is achieved by operating both fuel injectors in tandem. When the required flow of reformate is low, only the injector optimized for lower flow is energized. This capability increases the dynamic range of reformate flow that the reformer assembly can generate.

The present fast light-off catalytic reformer assembly and methods of operation rapidly produce high yields of reformate fuel. The produced reformate 118 may be bottled in a vessel or used to fuel any number of systems operating partially or wholly on reformate fuel. Such power generation systems for reformer assembly 150 may include, but are not limited to, internal combustion engines 170 such as spark ignition engines and diesel engines, hybrid vehicles 172, fuel cells 174, particularly solid oxide fuel cells 176, or combinations thereof. The present fast light-off reformer and method may be variously integrated with such systems, as desired. For example, the present fast light-off reformer may be employed as an on-board reformer for a vehicle engine operating wholly or partially on reformate, the engine having a fuel inlet in fluid communication with the reformer outlet 120 for receiving reformate 118 therefrom. The present fast light-off reformer and methods are particularly suitable for use as an on-board reformer for quickly generating reformate 118 for initial start-up of a system. The present reformer and methods are particularly advantageous for fueling internal combustion engines for reduced emissions, or for delivery to the exhaust stream of an engine to increase light-off rate or improve emissions reduction performance of exhaust components such as exhaust catalysts, NOx adsorbers, and/or particulate filters. Vehicles wherein a fast light-off reformer is operated in accordance with the present invention may include automobiles, trucks, and other land vehicles, boats and ships, and aircraft including spacecraft.

While the invention has been described by reference to certain preferred embodiments, it should be understood that numerous changes may be made within the spirit and scope of the inventive concepts described. Accordingly, it is intended that the invention not be limited to the disclosed embodiments, but that it have the full scope permitted by the language of the following claims.

1. A catalytic reformer assembly for generating hydrogen-containing reformate fuel from hydrocarbons, comprising:
a) a reactor;
b) a reforming catalyst disposed in said reactor, said catalyst having an upstream side for receiving a gas flow and a downstream side for discharging a gas flow;
c) a heat exchanger in fluid communication with said reactor and having a first flow side and a second flow side, wherein said first flow side is in communication with said catalyst upstream side and said second flow side is in communication with said catalyst downstream side; and
d) a combustor in flow communication with said heat exchanger including an air inlet for admitting air to said combustor, a gas outlet in communication with said heat exchanger first side, a first fuel injector for injecting hydrocarbon fuel into said combustor to form a fuel/air mixture, and an igniter for igniting said fuel/air mixture to form hot exhaust gases in said combustor, which gases may be passed through said heat exchanger first side, said reactor, said catalyst, and said heat exchanger second side.

2. A reformer assembly in accordance with claim 1 further comprising a second fuel injector.

3. A reformer assembly accordance with claim 1 wherein said reformer assembly is fluidly coupled to a fuel cell.

4. A reformer assembly in accordance with claim 3 wherein said fuel cell is a solid-oxide fuel cell.

5. A reformer assembly accordance with claim 1 wherein said reformer assembly is fluidly coupled to an internal combustion engine.

6. A reformer assembly accordance with claim 1 wherein said reformer assembly is fluidly coupled to an exhaust stream of an internal combustion engine.

7. A method for operating a reformer assembly having a reactor including a catalyst, a heat exchanger and a combustor, comprising the steps of:
a) admitting air into said combustor;
b) injecting hydrocarbon fuel into said combustor from a first injector to form a first fuel/air mixture;
c) igniting said first fuel/air mixture to form hot exhaust gases;
d) passing said hot exhaust gases through a first flow side of said heat exchanger to heat said first flow side;
e) passing gases exhausted from said heat exchanger through said reactor to heat said reactor and said catalyst;
f) passing gases exhausted from said reactor through a second flow side of said heat exchanger to heat said second flow side; and
g) terminating ignition of said fuel/air mixture to terminate formation of hot exhaust gases.

8. A method in accordance with claim 7 comprising the further steps of:
a) adjusting the ratio of fuel to air in said first fuel/air mixture to form a second fuel/air mixture for reforming;
b) passing said second fuel/air mixture through said first flow side of said heat exchanger;
c) passing said second fuel/air mixture through said heated catalyst to generate reformate; and
d) passing said reformate through said second flow side of said heat exchanger.

9. A method in accordance with claim 7 comprising the further steps of:
a) providing a second fuel injector disposed in said reactor;
b) shutting down said first fuel injector;
c) injecting hydrocarbon fuel from said second fuel injector into said reactor to mix with said admitted air to form a second fuel/air mixture for reforming; and
d) passing said second fuel/air mixture through said heated catalyst to generate reformate.

10. A method in accordance with claim 7 wherein said hydrocarbon fuel is selected from the group consisting of natural gas, light distillates, methanol, ethanol, higher alcohols, propane, naphtha, kerosene, gasoline, diesel fuel, and combinations thereof.

11. A method for operating a reformer assembly having a reactor including a catalyst, a heat exchanger and a combustor, comprising the steps of:
a) admitting air into said combustor;
b) injecting hydrocarbon fuel into said combustor from a first injector to form a first fuel/air mixture;
c.) passing said first fuel/air mixture from said combustor through a first flow side of said heat exchanger into said reactor;
d.) providing a second injector downstream of said first injector;
e.) injecting hydrocarbon fuel from at least one of said first injector and said second injector to form a second fuel/air mixture for reforming;
f.) passing said second fuel/air mixture through said catalyst to generate reformate; and
g.) passing said reformate through a second flow side of said heat exchanger.
